(19) United States
(12) Patent Application Publication
(10) Pub. No.: US 2008/0021098 A1
(43) Pub. Date: Jan. 24, 2008

(54) Antifungal Compositions

(75) Inventors: Thomas McGee, Nyack, NY (US); Andreas Natsch, Uetikon (CH)

Correspondence Address: NORRIS, MCLAUGHLIN & MARCUS, 875 THIRD AVE, 18TH FLOOR, NEW YORK, NY, 10022, US

(73) Assignee: GIVAUDAN SA, Vernier (CH)

(21) Appl. No.: 10/597,542

(22) PCT Filed: Feb. 4, 2005
(86) PCT No.: PCT/CH05/00063

§ 371 Date: Jul. 28, 2006

Related U.S. Application Data
(60) Provisional application No. 60/547,120, filed on Feb. 24, 2004.

(51) Int. Cl. A01N 31/02; A01N 31/04; A01N 35/02; A01N 35/04; A01N 43/08; A01N 43/30; A01P 3/00

(52) U.S. Cl. 514/462; 514/464; 514/473; 514/693; 514/699; 514/703; 514/730; 514/733; 514/739

(57) ABSTRACT

A method of simultaneously preventing the growth of fungi on substrates, particularly those exposed to an atmosphere, and imparting thereto a desired odour, by applying thereto a fragrance whose fragrant properties are derived mainly from the presence in the fragrance of at least two fragrance components selected from the group consisting of certain selected cyclic aldehydes, cyclic alcohols, branched or unbranched linear aldehydes, branched or unbranched linear alcohols, phenols and lactones. The method is particularly effective in supplying the necessary fragrance and antifungal properties in the vapour phase, thus avoiding any potentially harmful or damaging contact with liquid preparations.

This invention relates to a method of preventing fungal growth and to anti-fungal compositions for use therein, in the vapour phase.

Mould growth in the home is common. It is especially prevalent in enclosed spaces and in humid areas such as bathrooms, but it can also be found in curtains and wallpaper, and on clothing and footwear. It is not only unsightly, but it can also constitute a health hazard as some moulds generate spores that can cause allergic reactions in humans.

Many known fragrance ingredients, including essential oils, are known to have anti-fungal properties. These ingredients have been formulated in the form of aqueous compositions that are intended to be washed or sprayed over areas infected with mould growth. However, it is often undesirable to apply liquids to delicate substrates such as certain items of clothing, or to place liquid formulations in close proximity to such delicate substrates. Furthermore, the residual moisture left behind may act to promote further mould growth once the active ingredients have dispersed or degraded.

The possibility of using the anti-fungal properties of fragrance compositions in the vapour phase has been described, for example, in EP 1 214 879. However, in this particular case, the object of the invention is to use an anti-fungal component that consists of minor proportions of two specific fragrance components that react synergistically and that do not detract from the main fragrance.

It has now been found that it is possible to provide a method that provides both a high level of protection against fungal growth and a pleasant odour. The invention therefore provides a method of simultaneously preventing the growth of fungi on substrates and imparting thereto a desired odour, by supplying to the substrate a fragrance whose fragrant properties are derived mainly from the presence in the fragrance of at least two fragrance components selected from the group consisting of
a) cyclic aldehydes selected from 2-methyl-3-phenyl-2-propenal, 2-phenyl-propanal, 4-methyl-benzaldehyde, 2-phenyl-ethanal, 3-phenyl-propanal, 4-methyl-phenyl acetaldehyde, 4-methoxy-benzaldehyde, 1-carboxaldehyde-2,4-dimethyl-cyclohex-3-en, 3-(4-methoxyphenyl)-2-methyl-propanal, 1,3-benzodioxole-5-carboxaldehyde, 3-methyl-5-phenyl-pentanal, 1-carboxaldehyde-2,4,6-trimethyl-cyclohex-3-en, alpha-methyl-1,3-benzodioxole-5-propanal;
b) cyclic alcohols selected from 3-phenyl-2-propen-1-ol, 4-(1-methylethyl)-benzene methanol, 2-phenyl-ethanol, 3-phenyl-propanol, 3-(4-methyl-3-cyclohexenyl)-butanol, 2-methyl-4-phenyl-butan-2-ol, 2,2-dimethyl-3-(3-methyl phenyl)-propanol, 3-methyl-5-phenyl-pentanol, 2-methyl-5-phenyl-pentanol;
c) branched or unbranched linear aldehydes selected from 3,7-dimethyl-octa-2,6-dien-1-al, 2,4-nonadienal;
d) branched or unbranched linear alcohols selected from 10-undecenol, 1-nonanol, (e)-3,7-dimethyl-octa-3,6-dienol, (z)-3,7-dimethyl-octa-3,6-dienol, 3,7-dimethyl-6-octen-1-ol, 9-decenol, 2,6-nonadienol;
e) phenols selected from carvacrol, dihydro eugenol, eugenol, isoeugenol, thymol; and
f) lactones selected from 5-hexyl-furan-2(3h)-one, dihydro-5-pentyl-2(3h)-furanone, 4-methyl-5-pentyl-dihydo-2(3h)-furan-2-one, 8-methyl-1-oxaspiro[4,5]-decan-2-one.

In one aspect of the invention, there is provided a method of simultaneously preventing the growth of fungi on substrates exposed to an atmosphere and imparting thereto a desired odour, by supplying to the atmosphere a fragrance whose fragrant properties are derived mainly from the presence in the fragrance of at least two fragrance components selected from the group as hereinabove defined.

This vapour phase application surprisingly can exert an effective and prolonged anti-fungal effect in relatively large enclosed atmospheric volumes.

The invention additionally provides a volatile composition that simultaneously provides both fragrance and anti-fungal activity in the vapour phase, the composition comprising at least two fragrance components as hereinabove described.

In a further aspect of the invention, it has been found that the abovementioned fragrance components also deliver excellent results in the liquid phase. The invention therefore also provides a method of simultaneously preventing the growth of fungi on substrates and imparting thereto a desired odour, by applying thereto a liquid preparation comprising a fragrance whose fragrant properties are derived mainly from the presence in the fragrance of at least two fragrance components selected from the group as hereinabove described.

The invention additionally provides a volatile composition that simultaneously provides both fragrance and anti-fungal activity in the liquid phase, the composition comprising at least two fragrance components as hereinabove described.

The fragrance for use in this invention comprises at least two of the fragrance component as hereinabove defined. Generally, more than two will be required to create a desired fragrance, but such creation lies within the ordinary skill of the performer's art.

In one particular embodiment, the fragrance component contains at least one compound selected from those having the following structures:

### 3-(4-methoxyphenyl)-2-methyl-propanal (commercial name “Fennaldehyde” (trade mark))

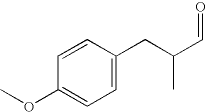

### alpha-methyl-1,3-benzodioxole-5-propanal (commercial name “Tropional” (trade mark))

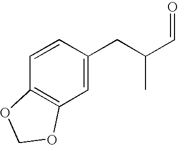

### 3-methyl-5-phenyl-pentanal (commercial name “Mefranal” (trade mark))

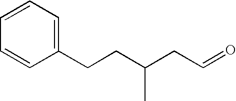

### 6-Methoxy-octahydro-4,7-methano-indene-1-carbaldehyde (commercial name “Scentenal” (trade mark))

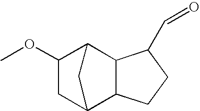

### undec-10-ene-1-ol (commercial name “alcohol C-11 undecylenic”)

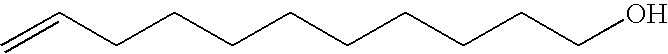

### 4-methyl-5-pentyl-dihydo-2(3h)-furan-2-one (methyl-tuberate)

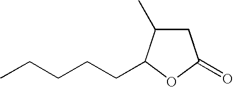

### 8-methyl-1-oxaspiro[4,5]-decan-2-one (Methyl-Laitone)

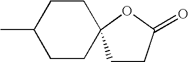

### 8,8-Dimethyl-1,2,3,4,5,6,7,8-octahydro-naphthalene-2-carbaldehyde (commercial name “Cyclomyral” (trade mark))

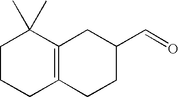

### 6,6-dimethyl-bicyclo[3.1.1]hept-2-ene-2-propanal (commercial name “Pinoacetaldehyde” (trade mark))

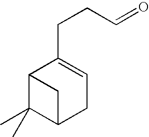

### 5-methyl-7-(1-methylethyl)-bicyclo[2.2.2]oct-5-ene-2-carboxaldehyde (commercial name “Lierral” (trade mark))

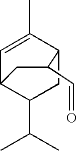

These materials are commercially-available synthetic fragrance compounds not reported to occur in nature, which materials have a particularly high antifungal activity, an activity not previously known.

An anti-fungal fragrance composition for use according to this invention preferably comprises fragrance components as hereinabove described to the extent of at least 50% by weight, and more preferably at least 70% by weight of the total composition.

The active concentration of these materials needed for an anti-fungal effect may be determined by placing various amounts of the materials in a gas tight container, with remotely-placed Petri dishes containing mould inoculum. Simultaneously, the level of the materials in the headspace can be measured using head space analysis techniques commonly known in the art. The minimal amount needed in the headspace to control mould growth can be easily determined in this manner.

In this manner, it was surprisingly discovered that the anti-fungal fragrance compositions useful in the present invention containing the aforementioned active component may diffuse into the vapour phase to give a head space concentration of anti-fungal fragrant ingredients of at least 2 micrograms per liter. In some cases, the concentration was more than 3 micrograms per liter, and in some cases even in excess of 10 micrograms per liter. Such concentrations permit the achievement of an effective and prolonged anti-fungal effect in even relatively large enclosed volumes, such as those in household bathrooms, something that has not hitherto been possible.

The anti-fungal fragrance compositions are effective against all common household fungi such as Aspergillus, Cladosporium, Penicillium, Phoma, and Aureobasidium.

Typically, compositions of the present invention may be effectively employed in enclosed volumes of all sizes. These are typically closets, bathrooms, basements and the like, but they can also be employed in smaller volumes where antifungal properties are needed, such as boxes, crates and packing cases.

Anti-fungal fragrance compositions as hereinabove described may be formulated neat as a liquid contained in a suitable package, or they may be formulated with any convenient delivery vehicle known for delivering fragrance compositions. For example, the fragrance composition may be incorporated into a gel, encapsulated in granules or absorbed on to porous bodies to form powders. Preferred delivery vehicles are described in more detail hereinunder.

The anti-fungal fragrance composition may be incorporated in such vehicles in varying amounts that may depend on the nature of the delivery vehicle, and the nature of the enclosed space to be treated, for example its volume and the degree of humidity to be encountered. Preferably however, the anti-fungal fragrance composition is employed in gels in amounts in excess of 50 wt %, more particularly 50 to 99 wt %. When the anti-fungal fragrance composition is contained in a powder, it may be present in amounts of 20 to 80 wt %, more particularly 40 to 70 wt %.

Anti-fungal fragrance compositions as hereinabove defined may consist entirely of the fragrance components as hereinabove described. However, in order to permit the formulator a certain latitude in creating interesting odour notes, it is preferable that the compositions additionally contain a fragrance base. The fragrance base may contain any fragrance ingredients known in the art, other than those anti-fungal compound groups or compounds referred to hereinabove. More specifically, the base may contain materials that can be selected from naturals such as the essential oils of armoise, basil, bay, bois de rose, caraway, cardamon, cedarwood, cinnamon bark, coriander, clovebud, estragon, fennel juniper berries, lemongrass, marjoram, neroli, oakmoss, orange, rosemary, rose, thyme, wintergreen, clove, pimento berry, bitter almond and pennyroyal and their active constituents and mixtures thereof. The fragrance materials can also be selected from synthetic aroma chemicals such as one or more of the following classes of compounds: alcohols, aldehydes, ketones, esters, acetals, oximes, nitriles and ethers.

The compositions may additionally contain other excipients commonly used in fragrance compositions, such as colourants, antioxidants, UV screens, and denaturants. Non-fragrance chemical fungicides that will co-volatilize, preservative, solvents and the like may be incorporated. As solvents, one can use any of those known to those skilled in the art such as hydrocarbons, dipropylene glycol; triethylene glycol, diethyl phthalate; benzyl alcohol; benzyl benzoate; propylene glycol; glyceryl triacetate; ethanol; and isopropanol.

Examples of gels for the delivery vehicle are well known in the prior art. One can mention in particular natural gums such as carrageenans, high-methoxyl pectins, agars, gelan gums and gelatins or modified polysaccharide, for example, a muccopolysaccharide crosslinked in the presence of a cationic crosslinking agent, or superabsorbent substances, such as starch based systems, chemically modified cellulose and or polymer of acrylic acid, methacrylic acid or a salt thereof, which form a gel with a hydrophilic medium. However as these types of gel unable to absorb a high fragrance load the system must be heated or exposed to a fan to permit the diffusion of sufficient fragrance. The most preferred gels are those that can contain a fragrance load in excess of 50% (w/w) such as fumed silica gels (Carbosil (trade mark)), or functionalised polymers that are cross-linked in situ, such the cross linked polymer system comprising functionalised liquid polymer and a copolymer of ethylene and maleic anhydride as described in U.S. Pat. No. 5,780,527 or a gel such as that described in U.S. Pat. No. 5,643,866 in which the fragrance is gelled with one or more glycols and dibenzylidene sorbitol acetal. These gels can maintain a minimum concentration the fragrance composition above 2 micrograms per liter of headspace for the useful life of the product without the need to heat or use a fan to enhance the diffusion.

Such gels may be contained in a suitable cartridge made of glass or plastics material. The plastics material may be, for example, a thermoplastic polymer such as polyethylene, polypropylene, polyvinyl chloride, Barex (trade mark) and polyethylene terephthalate, and the cartridge may be formed by any suitable method, such as injection or thermoform moulding. Usually gel in the cartridge is covered with a vapour-impermeable barrier such as aluminum foil or nylon film, which is removed prior to use. Where the gel is self-supporting, it may be directly exposed to the air. If it is not self-supporting, it is covered with a permeable film through which the specified fragrance composition can migrate to be released as a vapour at the outer surface. Suitable types of permeable film are flexible thin film of a thermoplastic polymer such as polyethylene, isotactic polypropylene, cellulose acetate, and the like. Another suitable type is a microporous type (submicron pores), such as isotactic hydrophobic polypropylene film sold as CELGARD (trade mark). Microporous thermoplastic polymer films are described in U.S. Pat. No. 3,055,297, incorporated herein by reference. Such a cartridge can be heated by being in thermal contact with an electrical-resistance heater, which receives its energy, for example, from a wall power outlet.

When the delivery vehicle is in the form of a gel, the most preferred gels are those that are able to contain a load in excess of 50 wt %. Suitable gels include fumed silica gels or functionalised polymers that are cross-linked in situ.

When the compositions are provided in a neat liquid form, they may be packaged in such a way as to permit effective diffusion from the packaging. One such diffusion means may be provided by a wick system, optionally including means, such as a heater and or a fan, to promote evaporation and diffusion of the compositions into the surrounding environment. Such systems are well known in the art.

Alternatively, the compositions may be dispensed via a nebulisation system to provide continuous or automatic pulsing of fragrance, and anti-fungal activity. Again, this is well known to the art and suitable means can easily be provided. Examples include use of an ultrasonic piezoelectric transducer, optionally assisted by a fan, pumping through a venturi or passing through a high voltage field. Such systems are ideally suited to delivering at least a concentration of the fragrance above 2 micrograms per liter.

When the delivery vehicle consists of a powder, the powder may be composed of porous or absorbent bodies that take up the anti-fungal fragrance composition by absorption or by impregnation. Such absorbent bodies may be formed of materials such as silica gel, zeolites, calcium silicates, diatomaceous earth, charcoal, alumina, and the like. Preferably, one may choose a material that exerts no or substantially no chromatographic effects on the fragrance ingredients in the base or the anti-fungal actives, for example porous glass beads.

Alternatively, the powder may comprise granules that encapsulate the anti-fungal fragrance composition.

All manner of encapsulation technologies may be applied in the present invention. The particular encapsulating medium used will depend upon the nature of the material to be encapsulated, the desired release kinetics and release profile. Apprised of these factors, the skilled person would not have to resort to inventive activity to select a suitable encapsulating medium to achieve a desired result.

Encapsulation techniques suitable in the present invention include spray-drying, complex coacervation, phase separation techniques (both aqueous and organic phase separation), cyclodextrin molecular encapsulation, yeast-cell encapsulation, in-situ polymerisation, coating, and extrusion. All of these are well known to the art and application to the present invention is straightforward.

Particles of anti-fungal composition may also be coated with encapsulating media of any of the film-forming materials referred to hereinabove. Coating techniques may be used to coat particles, usually solid particles, of the composition, or even may be used to further coat encapsulated forms described herein above.

Coating may be carried out according to known techniques such as spray coating, pan coating, fluid bed coating, rotogranulator coating, annular jet coating, spinning disk coating, spray cooling, spray drying, filtermat drying, Multi Stage Drying (MSD) drum roll coating, freeze drying, and spray chilling.

The skilled person will appreciate that the particular technique used and the encapsulating material employed will depend upon the nature of the material to be encapsulated and the type of release characteristic that is sought to be achieved.

Powders referred to herein above preferably are capable of having a composition load in excess of 20%, preferably 30% by weight. They can be contained in a glass or plastic container with a plastic lid, having holes through which the fragrance will diffuse; the lid may also be designed to enhance air flow for better fragrance delivery to the environment. The powder may also be contained in a sachet, characterized by having permeability to vapours, wherein the powder material is included within the sachet. The powder can be mixed with inert materials to provide larger surface area for diffusion, provided that the powder does not absorb or interact with the fragrance vapour.

When the antifungal composition of this invention is directly applied to a substrate in the liquid phase, it can either be dissolved in a suitable organic solvent, which include ethanol, isopropanol, propylenglykol, dipropyleneglycol or it can be dissolved in water along with surfactants and emulsifying agents. Surfactants can be selected from the group of anionic, non-ionic amphoteric or cationic surfactants and any mixtures thereof. Liquid formulations can additionally include solvents, colorants, preservatives and further excipients. Suitable liquid formulations contain 0.3-20%, more preferably 0.6-10% of a fragrance composition as specified above.

There now follows a series of non-limiting examples that serve to illustrate the invention.

### EXAMPLES

1) Determination of Minimal Headspace Level Required for Antifungal Activity

In order to determine the effective level of the anti-mould fragrance compounds needed for anti-mould vapour phase activity, an olfactometer is constructed that allows delivery to the fungal growth substrate of a constant concentration of fragrance vapour. A stream of nitrogen is saturated with the fragrance component, and the fragrance-saturated gas is then diluted with water saturated air at different ratios. This mixture is then blown continuously through enclosed acryl-glass boxes and the headspace is measured by sampling 1 ml gas sample with subsequent analysis in the gas chromatograph. Once a steady state in the acryl-glass box is reached (usually within 1-3 days), a fungal inoculum on a relevant substrate is added to the box, and fungal growth during a test phase of 7 days is evaluated.

The following relevant substrate—inoculum combinations were used:
(a) White pieces of cotton fabrics were soaked with a solution of potato dextrose broth diluted to a final concentration of 5% containing spores from the fungal test strain Cladosporium sphaerospermum IK-65 diluted to a final density corresponding to an optical density at 600 nm of 0.01. The test strain IK 65 was isolated from moist fabrics having fungal off odors, and it is a typical strain growing on fabrics as substrate.
(b) White plaster used for fixing ceramic tiles in bathrooms was spread homogenously on the back of 35 mm Petri dishes. On each Petri dish, 160 μl of a fungal inoculum was evenly spread. It contained potato dextrose broth diluted to a final concentration of 50% and spores from the fungal test strain Cladosporium sphaerospermum MTL diluted to a final density corresponding to an optical density at 600 nm of 0.004. The test strain MTL was isolated from a bathroom with vigorous mould growth on the plaster between tiles. Whereas commercially available test strains of Cladosporium sp. do not grow on this substrate, this strain was found to be an ideal test strain for this particular substrate.

Results from these experiments are shown in Table 1.

TABLE 1
Headspace level required to inhibit fungal growth

| | | Effect on fungal |
|---|---|---|
| compound | Headspace level | growth |
| 4-methoxy-benzaldehyde | 7.5 μg/L | over 90% inhibition |
| 1-carboxaldehyde-2,4-dimethyl- | 21 μg/L | over 90% inhibition |
| cyclohex-3-en | | |
| 3-(4-methyl-3-cyclohexenyl)- | 4.5 μg/L | 80% inhibition |
| butanol | | |
| 3-(4-methoxyphenyl)-2-methyl- | 1.9 μg/L | complete inhibition |
| propanal | | |
| 8,8-dimethyl-1,2,3,4,5,6,7,8- | 4.9 μg/L | complete inhibition |
| octahydro-naphthalene-2- | | |
| carbaldehyde | | |

2) Anti-Mould Fragrance Gels

An anti-mould fragrance formulation according to the present invention containing 67% cyclic aldehyde, 7% linear aldehydes, 5% linear alcohols and 21% non-active fragrance materials was made into gels as shown in Table 2 below:

TABLE 2

| | Gel A | Gel B | Gel C | Gel D |
|---|---|---|---|---|
| Aerosil* 200 (Fumed silica, | 7 | 0 | 0 | |
| Degussa) | | | | |
| Tomadol* 23-3 (linear | 1 | 0 | 0 | |
| alcohol ethoxylate, Tomah | | | | |
| Reserve inc.) | | | | |
| Lithene* N4 (Revertex Ltd) | | 17.35 | 0 | |
| 2.65% | | | | |
| Crodamet* 0-2 (Croda | | 2.65 | 0 | |
| Chemicals Ltd) | | | | |
| Deionized Water | | | 92.2 | 10.00 |
| Kathon* CG (Rohm & Haas) | | | 0.1 | |
| Carrageenan (Gelcarin* AF | | | 2.7 | |
| 650B, FMC biopolymers) | | | | |
| Propylene Glycol (Dow | | | | 69.00 |
| Chemical) | | | | |
| Sodium Stearate C-1(Witco) | | | | 10.00 |
| Triton* X-102 (Union | | | | 1.00 |
| Carbide) | | | | |
| Anti-mould fragrance | 92 | 80.00 | 5.0 | 10.00 |

*trade marks

Gel A was made by mixing the fragrance and Tomadol 23-3, and then adding in the Aerosil 200 with stirring.

Gel B was made by mixing the Lithene N4 with the fragrance and then Crodamet 0-2 was added under stirring.

Gel C was made heating the water and Kathon CG to 80° C. and then dissolving in the Carrageenan and fragrance.

Gel D is made by heating the propylene glycol and water to 70° C. and then adding the stearate to dissolve. Triton X-102 and fragrance were pre-mixed and finally added under stirring.

The gels (0.75 g to 10 g) were placed in glass jars, which have an exposed surface area of 15 sq. cm. Each jar is placed in a enclosed space 800 L PMMA container containing fungal inoculum from the strain Cladosporium IK65 on cotton surface as described in Example 1. Fungal growth at 1.5 m distance from the fragrant gel was monitored and headspace levels of the active components were determined by gas chromatography. Table 3 lists the results obtained with various amounts of these gels.

TABLE 3
Mould inhibition by fragranced gels

| | | | Effect on fungal |
|---|---|---|---|
| | | | growth on cotton |
| Gel | Amount of Gel | | support |
| Gel A | 1 | g | 90% Inhibition |
| Gel A | 2 | g | 100% Inhibition |
| Gel B | 0.75 | g | complete % |
| | | | inhibition |
| Gel C | 10 | g | 70% inhibition |
| Gel D | 10 | g | 70% inhibition |

It can clearly be seen that the gels with high fragrance load and no water phase are effective in inhibiting mould growth.

3) Anti-Mould Fragrant Powder

A spray dried powder was made based on an anti-mould fragrance formulation according to the present invention containing 30% cyclic aidehydes, 10% linear aldehydes, 10% linear alcohols, 20% cyclic alcohols, 10% lactones and 20% phenols according to the following procedure:

10.0 kg of polyvinyl alcohol Mowiol® 4-88, (Clariant AG, Switzerland) was dissolved in 90.0 kg deionised hot water (70° C.) to give a 10% polyvinyl alcohol solution. After cooling down to ambient room temperature 11.3 kg of fragrance was added and homogenised using a Ultra-Turrax T-52 stirrer (IKA GmbH, Germany) at maximum speed for 5 minutes. The resulting emulsion had a water content of ca 80 wt % and a fragrance droplet size of 0.8 μM as measured with Olympus BX50 light microscope (Olympus, Japan). The dynamic viscosity of the emulsion was 47 mPa·s (shear rate: 100 s⁻¹) measured with a Modular Compact Rheometer MCR 300 (Physica, Germany).

This emulsion was spray-dried using a standard spray-drying unit having a water evaporation capacity of 33 kg/h (air throughput of 1,500 M³/h) at 150° C. inlet and 70° C. outlet temperature and equipped with a two fluid nozzle operated at 3.0 bar air pressure.

The resultant powder had a total oil content of 51.2 wt % (0.6 wt % surface oil content), as measured by standard HPLC procedures, compared to a theoretical payload of 53.0 wt % perfume, resulting in a perfume oil recovery (initial retention) of 97% related to the HPLC total oil measurements. The total oil content measured by pulsed NMR method using an Oxford MQA6005 (Oxford Instruments IAG, UK) was 53 wt % (corrected for a residual moisture content of 3 wt % measured by Karl-Fischer).

The powder (3 g or 6 g) was placed in a glass jar which had an exposed surface area of 15 sq. cm. The jar was placed in an enclosed space 800 L PMMA container (internal space of 1.4 m×1.2 m×0.5 m). The humidity was raised to 100%. Fungal inoculum on relevant substrates was introduced along with the product into the PMMA container and the fungal growth at 1.5 m distance from the fragrant powder was monitored. As fungal inoculum, Cladosporium sphaerospermum IK65 was used.

In the presence of either 3 g or 6 g of the fragrant powder, no mould growth was observed, whereas a control not exposed to the fragranced powder showed vigorous mould growth. The headspace level of the most volatile compounds was measured by direct injection of 1 ml gas samples into the GC. The level of fragrance in presence of 6 g of spray dried powder was found to be 50 micrograms per liter of air, whereas the level of fragrance in presence of 3 g of fresh spray dried powder was found to be 30 micrograms per liter of air.

The same aged sample of 3 g powder was then used in a second experiment with fresh fungal inoculum. The sample used in this second experimental cycle released a fragrance level of 3 microgram per liter of air, and fungal growth on white pieces of cotton fabrics containing spores from the fungal test strain Cladosporium sphaerospermum IK-65 was inhibited. From this experiment, it appeared that 3 grams of a spray dried powder according the present invention can release an inhibitory level of active components of at least 3 micrograms per liter of air in a volume of 800 L for a prolonged time. Whereas 3 grams of the inventive powder was sufficient for an 800 L enclosed space, mould growth in even larger spaces could be blocked with larger samples of the powder.

4) Liquid Compositions

The following surface cleaners were prepared:

Formulation 1 (pH 11.5)

| % W/W | Ingredient | Trade name | Supplier |
|---|---|---|---|
| 4.00 | Isopropyl Alcohol | | |
| 0.50 | Fatty Alcohol C8-10 | Glucopon 425 | Cognis |
| | Alkyl Polyglycoside | | |
| 1.00 | Propylene Glycol n-Butyl | Dowanol PnB | Dow |
| | Ether | | Chemicals |
| 0.10 | Tetrasodium Ethlylene | Hampene 100 | Hampshire |
| | Diamine Tetra Acetic acid | | Chemicals |
| 4.00 | C9-11 Pareth-8 | Tomadol 91-8 | Cognis |
| 0.20 | Ammonia Hydroxide (28%) | | |
| 0.58 | Sodium Hydroxide (50%) | | |
| 1.5 | Fragrance (as example 2) | | |
| To 100 | Deionized water | | |

Formulation 2 (pH = 11.5)

| % W/W | Ingredient | Trade name | Supplier |
|---|---|---|---|
| 1.00 | Propylene Glycol n-Butyl | Dowanol PnB | Dow Chemicals |
| | Ether | | |
| 0.10 | Tetrasodium EDTA | Hampene 100 | Hampshire |
| | | | Chemicals |
| 4.00 | C9-11 Pareth-8 | Tomadol 91-8 | Cognis |
| 0.20 | Ammonia Hydroxide (28%) | | |
| 1.5 | Fragrance (as example 2) | | |
| To 100 | Deionized water | | |

Controls were made without fragrance and substituting with 1.5% deionized water.

The different formulations were then diluted in a fungal growth medium potato dextrose broth and challenged with an inoculum of the mold strain Cladosporium sphaerosperum MTL and mold growth was monitored over 7 days. The results were as follows:

| | | Containing 1.5% |
|---|---|---|
| | | fragrance according |
| Formulation | Unfragranced | to example 2 |
| 1 | 6.25% * | 1.56% |
| 2 | 3.125% | 1.56% |

* Given is the minimal inhibitory concentration of the final formulations suppressing fungal growth.

The results show clearly that the minimal concentration suppressing fungal growth of these formulations is significantly reduced by addition of the fragrance and thus the fungistatic effect of these formulations in these surface cleaners is significantly enhanced by the addition of a fragrance composition according to the present invention.

The same formulations and dilutions thereof in hard water were then directly challenged with a suspension of spores of the mold strain Cladosporium sphaerosperum MTL. After 1 h contact time, aliquots (5 μl) were removed and diluted in 100 μl fresh media in order to determine the fungicidal/sporicidal effect of these formulations. The growth of the mold in these subcultures was monitored. The results were:

| | | Containing 1.5% | Containing 1.5% |
|---|---|---|---|
| | | fragrance according | fragrance according |
| Formulation | unfragranced | to example 2 | to example 3 |
| 1 | 25%* | 6.25% | 6.25% |
| 2 | 25% | 6.25% | 6.25% |

*Given is the minimal sporicidal concentration of the final formulation in hard water which completely kills mold spores within 1 h contact time.

These data show that conventional spray formulations amended with a fragrance according this invention have a significantly higher sporicidal effect (i.e. 4-fold lower dilutions still efficiently kill mold spores). As such products are mainly used in the wet environment of a bathroom, dilution upon application is always happening, and thus efficient formulations should kill spores even in a diluted form.

1. A method of simultaneously preventing the growth of fungi on substrates and imparting thereto a desired odour, by supplying to the substrate a fragrance whose fragrant properties are derived mainly from the presence in the fragrance of at least two fragrance components selected from the group consisting of
a) cyclic aldehydes selected from 2-methyl-3-phenyl-2-propenal, 2-phenyl-propanal, 4-methyl-benzaldehyde, 2-phenyl-ethanal, 3-phenyl-propanal, 4-methyl-phenyl acetaldehyde, 4-methoxy-benzaldehyde, 1-carboxaldehyde-2,4-dimethyl-cyclohex-3-en, 3-(4-methoxyphenyl)-2-methyl-propanal, 1,3-benzodioxole-5-carboxaldehyde, 3-methyl-5-phenyl-pentanal, 1-carboxaldehyde-2,4,6-trimethyl-cyclohex-3-en, alpha-methyl-1,3-benzodioxole-5-propanal;
b) cyclic alcohols selected from 3-phenyl-2-propen-1-ol, 4-(1-methylethyl)-benzene methanol, 2-phenyl-ethanol, 3-phenyl-propanol, 3-(4-methyl-3-cyclohexenyl)-butanol, 2-methyl-4-phenyl-butan-2-ol, 2,2-dimethyl-3-(3-methyl phenyl)-propanol, 3-methyl-5-phenyl-pentanol, 2-methyl-5-phenyl-pentanol;
c) branched or unbranched linear aldehydes selected from 3,7-dimethyl-octa-2,6-dien-1-al, 2,4-nonadienal;
d) branched or unbranched linear alcohols selected from 10-undecenol, 1-nonanol, (e)-3,7-dimethyl-octa-3,6-dienol (z)-3,7-dimethyl-octa-3,6-dienol, 3,7-dimethyl-6-octen-1-ol, 9-decenol, 2,6-nonadienol;
e) phenols selected from carvacrol, dihydro eugenol, eugenol, isoeugenol, thymol; and
f) lactones selected from 5-hexyl-furan-2(3h)-one, dihydro-5-pentyl-2(3h)-furanone, 4-methyl-5-pentyl-dihydo-2(3h)-furan-2-one, 8-methyl-1-oxaspiro[4,5]-decan-2-one.

2. A method according to claim 1, in which the substrate is exposed to an atmosphere.

3. A method according to claim 1, in which at least one of the fragrance components is selected from the group consisting of:
3-(4-n-ethoxyphenyl)-2-methyl-propanal;
alpha-methyl-1,3-benzodioxole-5-propanal;
3-methyl-5-phenyl-pentanal;
6-Methoxy-octahydro-4,7-methano-indene-1-carbaldehyde;
undec-10-ene-1-ol;
4-methyl-5-pentyl-dihydo-2(3h)-furan-2-one;
8-methyl-1-oxaspiro[4,5]-decan-2-one;
8,8-Dimethyl-1,2,3,4,5,6,7,8-octahydro-naphthalene-2-carbaldehyde;
6,6-dimethyl-bicyclo[3.1.1hept-2-ene-2-propanal; and
5-methyl-7-(1-methylethyl)-bicyclo[2.2.2]oct-5-ene-2-carboxaldehyde.

4. A method according to claim 1, in which the fragrance is applied to the substrate in the vapour phase, by applying it to the atmosphere contacting the substrate.

5. A method according to claim 1, in which the fragrance is applied to the substrate directly in the liquid phase.

6. A composition comprising at least two compounds selected from the group consisting of:
a) cyclic aldehydes selected from 2-methyl-3-phenyl-2-propenal, 2-phenyl-propanal, 4-methyl-benzaldehyde, 2-phenyl-ethanal, 3-phenyl-propanal, 4-methyl-phenyl acetaldehyde, 4-methoxy-benzaldehyde, 1-carboxaldehyde-2,4-dimethyl-cyclohex-3-en, 3-(4-methoxyphenyl)-2-methyl-propanal, 1,3-benzodioxole-5-carboxaldehyde, 3-methyl-5-phenyl-pentanal, 1-carboxaldehyde-2,4,6-trimethyl-cyclohex-3-en, alpha-methyl-1,3-benzodioxole-5-propanal;
b) cyclic alcohols selected from 3-phenyl-2-propen-1-ol, 4-(1-methylethyl)-benzene methanol, 2-phenyl-ethanol, 3-phenyl-propanol, 3-(4-methyl-3-cyclohexenyl)-butanol, 2-methyl-4-phenyl-butan-2-ol, 2,2-dimethyl-3-(3-methyl phenyl)-propanol, 3-methyl-5-phenyl-pentanol, 2-methyl-5-phenyl-pentanol;
c) branched or unbranched linear aldehydes selected from 3,7-dimethyl-octa-2,6-dien-1-al, 2,4-nonadienal;
d) branched or unbranched linear alcohols selected from 10-undecenol, 1-nonanol, (e)-3,7-dimethyl-octa-3,6-dienol, (z)-3,7-dimethyl-octa-3,6-dienol, 3,7-dimethyl-6-octen-1-ol, 9-decenol, 2,6-nonadienol;
e) phenols selected from carvacrol, dihydro eugenol, eugenol, isoeugenol, thymol; and
f) lactones selected from 5-hexyl-furan-2(3h)-one, dihydro-5-pentyl-2(3h)-furanone, 4-methyl-5-pentyl-dihydo-2(3h)-furan-2-one, 8-methyl-1-oxaspiro[4,5]-decan-2-one.

7. A composition according to claim 6, in which at least one of the compounds is selected from the group consisting of:
3-(4-methoxyphenyl)-2-methyl-propanal;
alpha-methyl-1,3-benzodioxole-5-propanal;
3-methyl-5-phenyl-pentanal;
6-Methoxy-octahydro-4,7-methano-indene-1-carbaldehyde;
undec-10-ene-1-ol;
4-methyl-5-pentyl-dihydo-2(3h)-furan-2-one;
8-methyl-1-oxaspiro[4,5]-decan-2-one;
8,8-Dimethyl-1,2,3,4,5,6,7,8-octahydro-naphthalene-2-carbaldehyde;
6,6-dimethyl-bicyclo[3.1.1]hept-2-ene-2-propanal; and
5-methyl-7-(1-methylethyl)-bicyclo[2.2.2]oct-5-ene-2-carboxaldehyde.

8. A composition according to claim 6, in which the fragrance components comprise at least 50%, preferably 70%, by weight of the composition.

9. A composition according to claim 6, in which the composition is sufficiently volatile to allow it to be applied to a substrate by its volatilisation into an atmosphere contacting the substrate.

10. A non-aqueous fragrant gel, comprising at least 50%, preferably at least 70% by weight of a composition according to claim 6.

11. A fragrant powder, comprising from 20-80%, preferably from 40-70%, by weight of a composition according to claim 6.

12. An aqueous liquid composition comprising surfactant, water and from 0.3-20%, preferably from 0.6-10%, by weight of a composition according to claim 6.

13. A non-aqueous liquid composition comprising organic solvent and from 0.3-20%, preferably from 0.6-10%, by weight of a composition according to claim 6.
